(19) United States
(12) Patent Application Publication
(10) Pub. No.: US 2010/0306160 A1
(43) Pub. Date: Dec. 2, 2010

(54) Generating and determining bicycle configurations conforming to constraints

(75) Inventor: Clifford Simms, Boulder, CO (US)

Correspondence Address: WALDEAN A. SCHULZ;CONCEPTUAL ASSETS, INC., 440 JAPONICA WAY, BOULDER, CO, 80304-1712, US

(73) Assignee: CRUCIAL INNOVATION, INC., Boulder, CO (US)

(21) Appl. No.: 12/474,646

(22) Filed: May 29, 2009

(51) Int. Cl. G06N 7/02

(52) U.S. Cl. 706/52

(57) ABSTRACT

Systems and methods are described for determining a subset of conforming descriptions of a set of descriptions of bicycle configurations, which are combinations of candidate components, such as frames, forks, stems, handlebars, seat posts, and saddles. For determining whether a candidate description conforms, (1) a set of candidate components with a physical specification of each candidate component is accessed, (2) at least one biomechanical constraint is input, and (3) optionally a non-biomechanical constraint is input, such as weight, material, or price. An embodiment may generate a biomechanical constraint from a physical measurement taken from a particular bicycle and/or from a physical measurement taken from a particular cyclist.

### FIELD OF THE INVENTION

This invention relates to systems and methods of determining which bicycle configurations of a set of candidate configurations satisfy a prescribed biomechanical constraint or constraints. Further, this invention may derive the biomechanical constraint from an angle or a distance measured on a specific bicycle or on a specific cyclist.

### BACKGROUND OF THE INVENTION

A bicycle fit geometry—or simply a bike fit—may include one, some, or all of the locations, lengths, distances, angles, orientations, and shapes of all contact points or surfaces in a interface between a cyclist and a bicycle. The cyclist-bicycle interface may include pedals, saddle, handlebar grips, brake hoods, or aerobar grips. The shape or geometrical relationships among these interfaces may impose a very limited range of postures which a cyclist is able to assume on the bicycle. The orientation of the cyclist's posture with respect to vertical—that is, to the direction of the force of gravity—may also be significant. Likewise, the orientation of the cyclist's posture with respect to the forward direction may determine wind resistance. Furthermore, attainable power output and endurance are affected by a cyclist's posture. Posture may be modified by changing the size or geometry of the bicycle frame, pedal crank length, seat height, seat forward-aft location, handlebar height, handlebar geometry, stem length or angle, and the like. Some postures may optimize efficiency, such as for long distance racing. Some postures may optimize power output, such as for sprinting, for time trials, or for triathlons. Other postures may optimize comfort. A posture may optimize some other specific objective or style of riding. A personal bicycle configuration customized to optimally fit one cyclist may impose a very different posture on a second cyclist having different body dimensions or cycling goals. Therefore, a bicycle configuration is customized to both the body characteristics and the objectives of a specific cyclist.

Bicycle shops may charge hundreds of US dollars to optimize a personal bicycle configuration for a serious amateur or professional cyclist. Yet bike fits typically are performed manually using little more than the equivalent of a ruler, plumb line, protractor, and printed chart. Recently, higher-technology systems have commercially emerged, which can accurately and reproducibly acquire the measurements needed for a professional bike fitter to produce a good custom bike fit between cyclist and bicycle. Some of these commercially available systems can dynamically acquire the measurements in real time while the cyclist is pedaling a bicycle mounted on a trainer. An example of such a system is the Retül fit system manufactured by Crucial Innovation, Inc., (Boulder, Colo., USA). On some occasions a bike fit may be performed on a stationary bicycle or on an adjustable bicycle simulator, known as a fit bike. Examples of typical fit bikes are available from Serotta (Saratoga Springs, N.Y.) and Exit Cycling (San Marcos, Calif.).

The objective of a bike fit session may be to determine the configuration of a new custom bicycle or the reconfiguration of an existing bicycle by changing or adjusting components. Satisfying the objective may involve determining a configuration of some or all of the following components: a frame size and style, a stem length and handlebar geometry, a seat position, a steerer tube length and angle, a spacer stack on the steerer tube, locations of aero pads and grips, and a crank arm length. There may be many configurations of bicycle components which will conform to the biomechanical constraints characterizing a desired cyclist posture. The biomechanical constraints may have been derived from the measurements of a bicycle or a cyclist obtained during a bike fit session. Traditionally, even generating one such configuration of components may be more as the result of guesswork and product marketing than from rigorous methodology. One available tool to encourage a methodical approach to building a customized bicycle based on a bike fit session is the interactive Slowtwitch Geometry Calculator found on the Web site (http://www.slowtwitch.com/Fit_Calculator/fit_calculator.php) of Slowtwitch, Inc. (Valyermo, Calif.). The Geometry Calculator is based on measuring vertical and horizontal distances in two dimensions relative to the bottom bracket. However, the Geometry Calculator is only a sophisticated trigonometric algorithm against which to determine whether specific bicycle measurements satisfy the constraints suggested by the bike fit. Particularly, the Geometry Calculator itself does not generate any candidate description of a candidate bicycle configuration from a database of candidate bicycle components.

Therefore, an objective of the present invention is an automated system or method for generating a conforming description of a bicycle configuration, where a computed attribute value of the conforming description conforms to at least one biomechanical constraint, and where the description includes bicycle components selected from a database of candidate components. Enhanced embodiments may also include a further, non-biomechanical constraint. Also, embodiments may include the derivation of the biomechanical constraint from a geometrical measurement obtained from a specific cyclist or from a specific bicycle

### SUMMARY OF THE INVENTION

The present invention is directed toward a system for generating a conforming subset of a set of candidate descriptions of physical bicycle configurations when given at least one biomechanical constraint. Each configuration includes—that is, is a combination of—at least two components from a set of candidate components. The candidate components are specified in a database, which associates at least one geometrical specification with each candidate component.

One embodiment is a system comprising a computer-accessible database of candidate components and a programmable computer which can access the database. The programmable computer is programmed to access geometrical specifications of the candidate components in the database, input a biomechanical constraint, generate a set of candidate descriptions, compute an attribute value for each description in the set of the candidate descriptions, determine whether the computed attribute value conforms to the biomechanical constraint, and, if the attribute value does conform, then include the candidate description in a conforming subset of the set of the candidate descriptions. The computation of the attribute value uses the geometrical specifications associated with the candidate components included in the candidate description. The attribute value, for example, may be a range of possible distances between two reference points, one reference point on each of two components.

A further embodiment is a system in which the programmable computer is additionally programmed to input a non-biomechanical constraint to which the candidate description must also conform in order to be included in the conforming subset of the set of candidate descriptions.

Another embodiment is a system in which the programmable computer is further programmed to derive the biomechanical constraint from a dimensional measurement, which was measured on a specific bicycle or which was measured on a specific cyclist. The dimensional measurement may be a distance, or the dimensional measurement may be an angle.

Another embodiment is a method of generating a conforming subset of a set of candidate descriptions, wherein each description of the set of candidate descriptions describes a bicycle configuration, wherein each description references two or more components chosen from a set of candidate components, and wherein each description in the conforming subset of the set of candidate descriptions conforms to a biomechanical constraint. The method comprises accessing a database of specifications of the candidate components; inputting the biomechanical constraint, generating at least one candidate description describing a candidate bicycle configuration; computing an attribute value as a function of the candidate description of the candidate bicycle configuration; determining whether the attribute value conforms to the biomechanical constraint; and if the attribute value does conform to the biomechanical constraint, then including the candidate configuration in the conforming subset of the set of candidate descriptions. Each candidate description references two or more of the candidate components, which have specifications in the database.

A further embodiment is a method which additionally comprises inputting a non-biomechanical constraint to which the candidate description also conforms.

Another embodiment is a method which further comprises deriving the biomechanical constraint from a dimensional measurement, which was measured on a specific bicycle or which was measured on a specific cyclist. The dimensional measurement may be a distance, or the dimensional measurement may be an angle.

### BRIEF DESCRIPTION OF THE DRAWINGS

The accompanying drawings, which are incorporated herein and constitute part of this specification, illustrate presently preferred embodiments of the invention, and, together with the general explanation given above and the detailed explanation given below, serve to explain features of the invention.

FIG. 1 is a schematic drawing of a system embodiment of the present invention.

FIG. 2 is a flowchart, illustrating one specific order of steps involved in the operation of an embodiment.

FIG. 3 is a drawing of two bicycle components: a frame and a seat post, together with the local coordinate system axes of each.

### DETAILED DESCRIPTION

Various embodiments of the present invention will be described in detail with reference to the accompanying drawings. Wherever possible, the same reference numbers will be used throughout the drawings to refer to the same or like parts.

The following pages discuss the calculation of distances, angles, coordinates, shapes, and other quantitative geometrical relationships, which can be aspects characterizing a geometry of a particular bicycle configuration and which may represent an optimal fit for a particular cyclist. The geometrical characterization aspects of a configuration discussed herein are not exhaustive; certainly many others are possible. Embodiments are not meant to be limited to the aspects discussed herein. Computations involving distances, angles, planes, intersections, cylinder centerlines, coordinate systems, and related concepts are well known in 3-dimensional analytic geometry and are assumed to be familiar to those skilled in the art of 3-dimensional measurement and computation.

One way to describe the locations of relevant reference points on a specific configuration of a bicycle is to specify the locations relative to the bottom bracket, which may be considered the origin of a rectangular XY coordinate system. The vertical axis is sometimes called “Stack” and increases positively upward from the origin. One horizontal axis is sometimes called “Reach” and increases positively in the forward direction of the bicycle within the plane of symmetry of the bicycle frame. The Reach axis may be defined as parallel to the vector from the center of the rear wheel axle to the center of the front wheel axle. The Stack axis may be defined to be perpendicular to the Reach axis and in the plane of symmetry of the frame. A third axis—also horizontal—is often ignored but can be used to measure lateral offsets perpendicular to the plane of the frame. The three axes may be defined to be mutually orthogonal. The location of components which are not on the plane of the frame, such as handlebar grips, may be orthogonally projected onto the Reach-Stack plane, so then a 2-dimensional coordinate system may suffice for most purposes. Although alternative coordinate systems may be used, the 2-dimensional Reach-Stack coordinate system will be used herein for purposes of convenient, clear, and specific explanation.

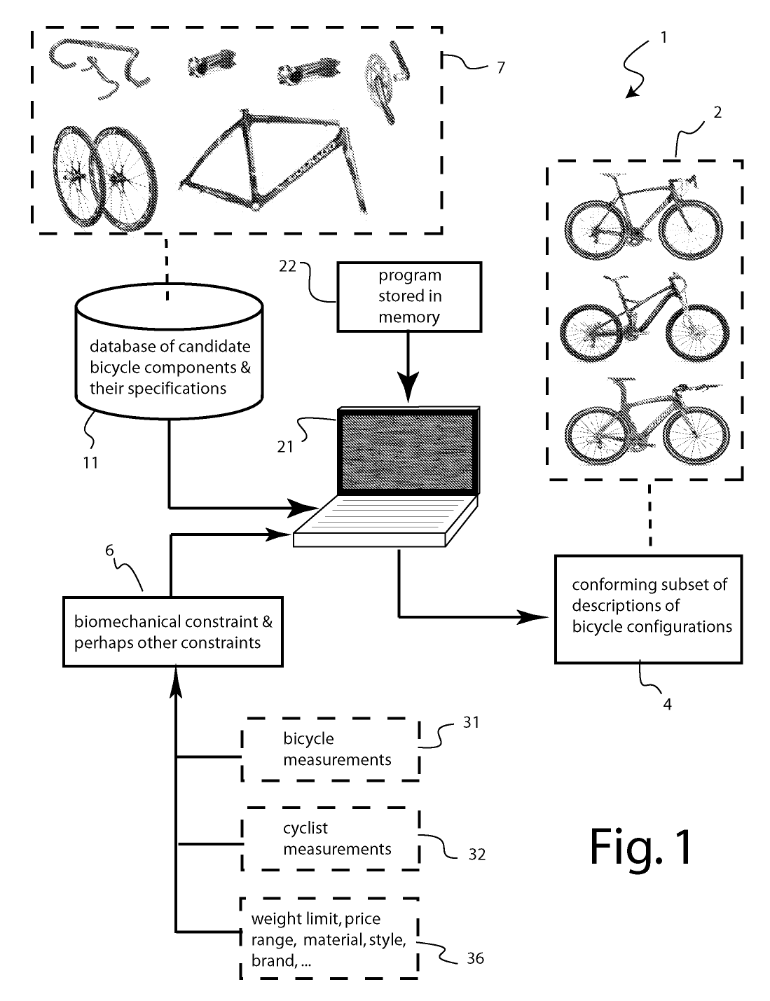

With reference to FIG. 1, an embodiment of a system 1 includes a programmable computer 21, a program 22 stored in the memory of computer 21, a database 11 of specifications of candidate bicycle components 7, and at least one biomechanical constraint 6 as an input. The output generated by the computer 21 is a conforming subset 4 of candidate descriptions of zero or more physical bicycle configurations 2. The physical bicycle components 7 and the physical bicycle configurations 2 are not elements of the invention, but are referenced to aid in explanation.

The bicycle components 7 and the bicycle configurations 2 illustrate the physical manifestations which respectively are specified in the database 11 and described by descriptions of bicycle configurations. The conforming subset 4 of candidate descriptions describes a computed subset of the physical bicycle configurations 2. The physical bicycle configurations 2 are potential combinations of the physical bicycle components 7, where each combination is a partial or complete bicycle. For the purposes of the following discussions, references to the physical bicycle components 7 may be treated—without confusion—as synonymous to their corresponding “virtual” candidate components in database 11. Similarly, the candidate bicycle configurations and the conforming subset 4 thereof are virtual assemblies of real, physical bicycle configurations 2. Therefore, references to the virtual assemblies and their corresponding physical configurations 2 may be considered synonymous without causing confusion.

The programmable computer 21 may be a desktop personal computer, a laptop computer, a handheld computer, a network of one or more computers, or some other programmable digital computing device capable of reading the database 11, inputting the constraint 6, and outputting some presentation of the conforming subset 4. Herein the programmable computer 21 will be referred to as simply the computer 21. The program 22 directs the operation of computer 21. The program 22 may be stored as a pattern of bit states in random-access electronic memory, read-only memory (ROM), magnetic or optical disks, magnetic tape, or some other form of computer-accessible digital memory. The program 22 may be a native binary machine code, an interpretable intermediate code such as Java, Python, or NET, or a higher-level human-readable source code such as C++. The operation of the program 22 will subsequently be described.

The database 11 may be a file of data records stored on a hard disk drive, an optical or magnetic disk, a computer network, holographic memory, random-access or read-only electronic memory, any other such computer-accessible digital memory medium, or a combination thereof. The candidate bicycle components, of which the database 11 contains specifications, may include some or all of the following: bicycle frames, saddles (seats), seat posts, handlebars, handlebar stems, front wheel forks, steerer tube spacers, areo bars and pads, cranksets, or other such components. Furthermore, the database 11 may include a predefined combination of two or more components, such as a frame with an integral seat post or a one-piece handlebar and stem. Still further, the database 11 may include a predefined set of components representing a “component kit” or a manufacturer's standard model of a whole bicycle, for example. In the description herein, a combination or set of components may itself be treated as a component.

The candidate bicycle components of particular interest herein are those which may affect cyclist posture. An embodiment may also take into consideration any other component and its specifications: such as a wheel having a diameter, a weight, a composition, and a spoke pattern. The candidate bicycle components in database 11 may be those of a single manufacturer or distributor or those of multiple manufacturers or distributors. Each component specification in database 11 includes at least one geometrical dimension—preferably more than one. Each dimension may be a length, an angle, or a shape. The specifications may further include weight, composition or material, price, color, style, part compatibility, and/or other non-geometrical attributes.

The specification of a candidate frame in the database 11 may include one or more of the following details:
the centerline axis of the seat tube or integral seat post,
the Reach-Stack coordinates of the top of the seat tube,
the centerline axis of the head tube,
the location coordinates of the top and bottom of the head tube,
the compatibility requirements for acceptable cranksets and steerer tubes,
the inside diameters of the seat tube, bottom bracket, and the head tube,
the cross-sectional shape required for an acceptable seat post,
non-geometrical characteristics like weight, material, color, and style,
the brand name of the manufacturer and model of the frame, and
miscellaneous details like waterbottle bracket lugs and brake fittings.
   Each location of interest on the frame can be expressed in Reach-Stack coordinates. Each axis may be expressed as a unit direction vector and a location on the axis relative to the Reach-Stack coordinate system.

The specification of a candidate seat post in the database 11 may include some or all of the following details:
minimum distance of the top of the seat post above the top of the frame,
maximum distance of the top of the seat post above the top of the frame,
outside diameter of the seat post,
cross-sectional shape of the seat post,
its construction material (such as steel, aluminum, carbon, or a hybrid),
its weight, and
its type and the details of how the seat post mates to the saddle.
   The details of how the seat post mates to the saddle may include some or all of the following:
the range of angles between the seat post axis and saddle rails,
the clamp width, offset, and range of tilt relative to the seat post centerline,
the compatibility and dimensions of the seat rails,
the height of the rail grooves above the bottom of the seat post, and
the separation distance between the rails of a compatible saddle.

The specification of a saddle in the database 11 may include some of all of the following:
the shape or contour of the top of the saddle,
coordinates of the rearmost and frontal locations of the saddle,
the length, diameter, and locations of the saddle rails, and
details of the saddle covering and resiliency.

The specification of a candidate front fork in the database 11 may include some or all of the following:
steerer tube shaft diameter and top cap location,
rake distance perpendicular to steerer tube axis,
distance of front wheel axle from the fork crown (or the bearing race),
the material, weight, and color, and
details such as presence of lugs or posts for disk or caliper brakes.

The specification of a candidate handlebar in the database 11 may include some or all of the following:
the diameter of the handlebar where it is clamped by the stem,
other stem compatibility details such as cross-sectional shape,
the distance between handgrips,
the locations of the handgrips relative to the clamp location,
the centerlines of the handgrips, and
the weight, the material, and the style or shape of the handlebar.
   A similar specification may apply to a candidate aerobar, together with the separation distance and range of locations for the elbow pads and for the handgrip extensions.

The specification of a candidate handlebar stem in the database 11 may include some or all of the following:
clamp diameters of the handlebar and of the fork's steerer tube,
the distance between the centerlines of the handlebar clamp and the steerer axis,
the angle at which the stem holds the handlebar,
the weight, and the material of the stem.

Other candidate components, such as spacers and crank sets, may be specified in ways similar to the above in the database 11.

All candidate bicycle components 7 represented in database 11 may have certain specification details in common, including some or all of the following:
retail suggested price and wholesale price,
weight, material, color,
manufacturer's name, component name, component part number,
supplier, availability, and number in stock.

The biomechanical constraint 6 may be a length value, such as the vertical distance between the bottom bracket and the top of the saddle or the horizontal offset between the center of the saddle and a hand grip, for example. Generally more than one such constraint will be input to the system 1. Furthermore, each constraint may be a range of numbers between a minimum and a maximum distance value. Alternatively, the constraint may be a single distance value but have a plus-or-minus tolerance distance associated with the single distance value.

Further, the biomechanical constraint 6 may be an angle value, such as the desired angle of a line between the bottom bracket and the middle of the saddle, where the angle is relative to a horizontal reference. The horizontal reference may be defined as a line between centers of the front and rear wheel axles. As with distance constraints, such an angular constraint may be a range of values between a minimum and a maximum value, or the constraint may be a single angle value with an associated plus-or-minus tolerance value.

Only a conforming subset 4 of candidate descriptions of bicycle configurations 2 will conform to the biomechanical constraint or constraints. If two or more constraints 6 are provided to the system 1, then normally all of the constraints 6 must be satisfied by all descriptions in the conforming subset 4. An exception may be a situation where at least two constraints 6 are explicitly prescribed as alternatives such that the conforming subset 4 need conform to only one of the alternative constraints.

The conforming subset 4 of candidate descriptions of bicycle configurations 2 may be presented in the form of a paper listing printed on a printer attached to the computer 21. The listing may consist of text only. The listing may include a graphical illustration or picture of the components. The illustration may show the components virtually assembled into a bicycle configuration. Each description in the listing of the conforming subset 4 may describe a set of specific bicycle components. For each component of each description in the listing, the listing may provide any or all of the following details:
a name of the component,
a name of a manufacturer,
a model or part number,
a color, a size or style or shape, weight, composition material, and
any other information which uniquely identifies the component.
   Alternatively, the conforming subset 4 may simply be a listing or a table—having text or pictorial fields—presented on the display screen of the computer 21. Alternatively, the conforming subset 4 may be output as a computer-readable file of data presented as a physical encoding on a magnetic or optical disk or as an array of device states in a solid state memory.

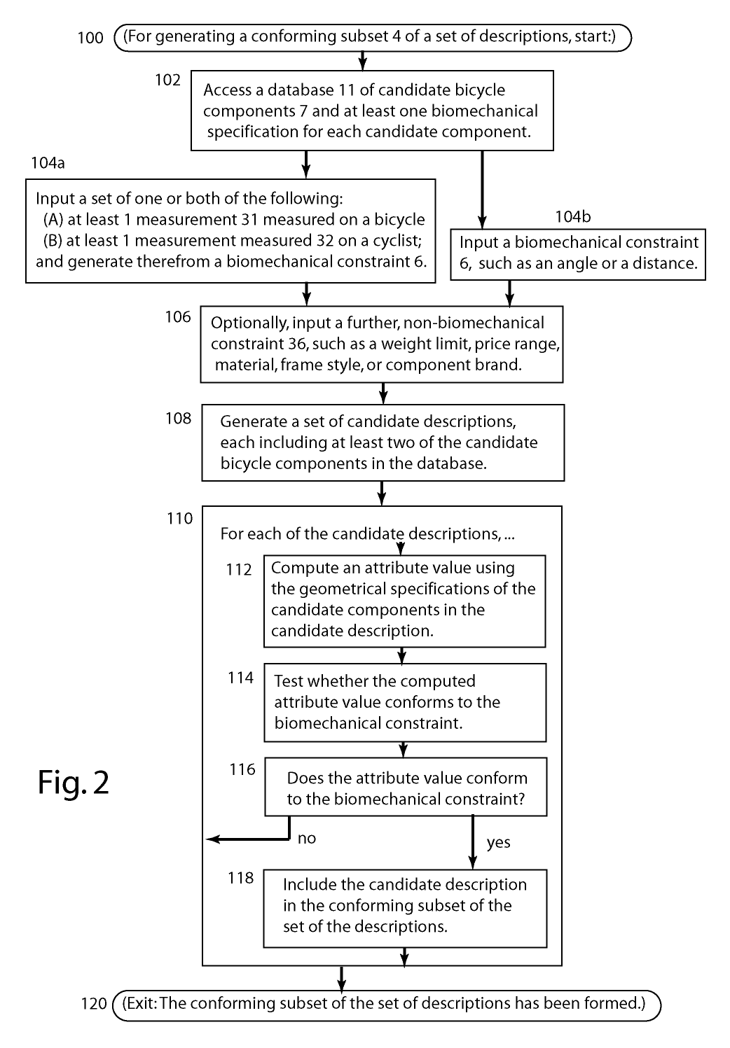

With reference to FIG. 2, a program 22 programs computer 21 to perform steps in an embodiment of system 1. An embodiment may execute the steps in the order to be explained below or may execute the steps in any other order which can generate a conforming subset 4.

The program 22 starts and may access a database 11 of candidate bicycle components: steps 100 and 102. The program 22 may input at least one biomechanical constraint 6: step 104b. The constraint 6 may be input, for example, by soliciting direct keyboard entry by the operator of computer 21 or by soliciting input through a graphical user interface. In the case of a graphical user interface, the operator may input the constraint by means of a menu of types of constraints, of an on-screen virtual numeric keypad, of on-screen virtual dials or slider controls, or of voice recognition hardware and software.

Instead of—or in addition to—directly entering the biomechanical constraint or constraints, the operator may enter one or more of the following measurements: a measurement 32 measured on an existing bicycle or bicycle simulator; and/or a measurement 31 measured on a cyclist. From the one or more measurements, the program 22 may automatically derive a biomechanical constraint 6: step 104a. The deriving of the biomechanical constraint 6 may be implemented in any of several ways or a combination of the ways. The ways include table lookup, execution of an algorithm to estimate a biomechanical constraint 6 from the measurements 31 and/or 32, or use of a bicycle fitting system to provide at least one biomechanical constraint 6.

An example of the table look-up may be a chart which recommends a saddle-to-bottom-bracket distance, based on a cyclist's inseam measurement. An example of the algorithm may be the aforementioned Slowtwitch Geometry Calculator. An example of the bicycle fitting system may be the aforementioned Retül fit system. The deriving of the biomechanical constraint 6 may be performed manually by a human being, performed automatically by the computer 21, or performed as a semiautomatic collaboration of computer 21 and the operator of computer 21.

Optionally, the operator may supply zero or more non-biomechanical constraints 36 as input to the computer 21. The non-biomechanical constraints may include any, some, or all of the following:
the identity of a specific component for all conforming subsets,
the brand name or distributor of a component for all conforming subsets,
material, style, or color of a component for all conforming subsets,
total weight limit of each bicycle configuration in the conforming subset 4,
the size, shape, or diameter of a component 7,
an estimated location of a center of mass for the cyclist,
the wheelbase, the steering rake or trail, or other handling characteristic,
price range of each bicycle configuration 2, or
any other such limiting characteristic.
   The conforming subset 4 of candidate descriptions will also conform to these non-biomechanical constraints 36. The size, shape, or diameter of a component 7 belonging to a configuration in the conforming subset 4 formally is a geometrical specification. However, such a specification herein is classified as non-biomechanical, because generally it does not materially affect the posture of a cyclist on any of the bicycle configurations described by the conforming subset 4.

With continued reference to FIG. 2, the program 22 can generate a set of candidate bicycle configurations 2, which in effect are “virtually assembled” combinations of candidate bicycle components drawn from database 11: step 108. Because of the enormous number of potential combinations and the time required by program 22 to analyze each combination, not all possible combinations may be considered. That is, program 22 may use heuristic methods and short-cuts to quickly prune the theoretical set of all possible combinations. For example, not all front forks will fit into any given bicycle frame, because the fork and steerer tube diameters do not match. Similarly, some bicycle frames require that a mating seat tube have a tear-drop cross-sectional shape, which may eliminate traditional seat tubes. In other words, the database 11 may be organized so that only certain subsets of one kind of component—such as handlebars—can be combined with a specific component—such as a handlebar stem. Typically, handlebars and stems are available in only several standard specified sizes (diameters). Each size might appear as distinct subsets of components in database 11.

Program 22 may then process and evaluate some or all of the candidate descriptions of bicycle configurations: step 110. To perform the evaluation of each such candidate description, program 22 may compute at least one attribute value for each candidate description: step 112. This computation of the attribute value or values can be computationally complex and is subsequently discussed in detail. Each attribute value is some composite value derived from the specifications of all the components constituting the specific bicycle configuration described by the candidate description being evaluated. The specification of each candidate component may include geometrical and/or non-geometrical details. The derived attribute value may be computed, for example, as the sum of values of some common specification detail of all constituent components of the bicycle configuration—such as a weight of each constituent component. Another example of a derived attribute value may be the cumulative percentage of each composition material found in all of the constituent components.

An example of an attribute value may be the distance between two reference points, such as the center of the bottom bracket of the frame and the center of the top of the saddle. Another attribute value may be a steering property such as the computed trail distance of the front wheel. Still another attribute may be the forward horizontal distance between the center of the saddle and the center of a handlebar grip. An attribute value, for example, may be the angle—or a range of angles—between the seat tube and a horizontal reference line.

An attribute value which may be particularly important is the Reach-Stack coordinate pair of a reference point located on a specific component. For example, the Reach-Stack coordinates of the center of the top of the saddle may be an important attribute value. The Reach-Stack coordinate pair would describe the location that the reference point would occupy if the physical component were positioned on the physical bicycle configuration described by the candidate description being processed and evaluated. That is, a “virtual”—or simulated—bicycle is constructed from the candidate components of each candidate description. For example, the reference point may be the center or nose of the saddle, the center of one handlebar or aerobar grip, or the center of the right elbow pad of the aerobar. (Further detail about the virtual construction of a candidate bicycle will be given below.)

Once the desired attribute value has been computed for a candidate description, the value may be tested to determine whether the value—and therefore the candidate description producing the value—conform to the at least one constraint 6: step 114. If the attribute value does not conform to the constraint 6, the program 22 does nothing further with the candidate description just tested: step 116. If the attribute value does conform to the constraint 6, the candidate description just tested is included in the conforming subset 4 of descriptions of bicycle configurations: step 118. Whether or not the candidate description conforms, the program 22 may evaluate another generated candidate description.

The constraint 6 may have been directly input to the program 22 (step 104b) or may have been derived from at least one measurement 31 or 32 input to the program 22. This is meaningful only when there is a straightforward or a functional relationship between at least one constraint 6 and the computed attribute value. For example, if a biomechanical constraint 6 is a range of distances between the nose of the saddle and an areo handgrip, then evaluation of the constraint may be determined by examining the Reach-Stack location of the nose of the saddle and the Reach-Stack location of the areobar handgrip. If the Euclidean distance between the two locations falls in the range of the constraint 6, then the candidate description is included in the conforming subset generated so far.

The program 22 may in like manner process any remaining, unprocessed candidate description in the generated set of candidate descriptions to determine whether the remaining unprocessed candidate description conforms to the biomechanical constraint or constraints. If there is a non-biomechanical constraint or constraints, the program also determines whether the remaining unprocessed candidate description conforms to the non-biomechanical constraint or constraints.

The accessing of the database 11, the inputting of the biomechanical constraint 6, and the optional inputting of a non-biomechanical constraint may be performed in parallel or in an order other than that described above. Furthermore, the database 11 may be accessed repeatedly, such as at least once each time an attribute value is computed for a candidate bicycle description. Similarly, the program 22 may generate a set of candidate configurations and thereafter evaluate them one-by-one or in parallel; or the program 22 may evaluate a candidate configuration immediately after it is generated.

In order to compute specific Reach-Stack coordinates of a given reference point on a specific component on the physical bicycle configuration, the program 22 must virtually assemble the bicycle configuration using the candidate components 7 referenced in the candidate description being processed and evaluated. Given a location and an orientation of a component, and given an appropriate specification of the component in the database 11, the Reach-Stack coordinates of the component can be computed relative to the bottom bracket-the origin of the Reach-Stack coordinate system. Because many components are adjustable, such as seat post height, a Reach-Stack attribute may be a range of pairs of coordinates. For instance, the range may be represented as a quadrilateral within the two-dimensional Reach-Stack coordinate system, which may be defined on the plane of symmetry of the frame. For example, the range of possible locations for the center of a saddle may form a parallelogram. In other words, a seat post may be telescoped up and down within a given frame, which holds the seat post at an angle with respect to vertical; independently, the saddle may be moved horizontally on its rails. The center of the saddle thus may depend on the following:
the choice of seat post and how far it is inserted into the given frame,
the kind of a seat clamp and saddle,
height of the saddle top above the rails, and
how far the rails of the saddle are moved forward-aft in the seat clamp.

To support such virtual assembly of candidate bicycle components 7 from the database 11 into a candidate bicycle configuration, relevant geometrical and other specifications must appear in the database 11 for each candidate component. The kind of component may dictate what specification values are needed. The virtual assembly is a straightforward exercise in 2-d analytic geometry for computer programmers skilled in the art of points, vectors, and matrix multiplication. Transformation matrices are commonly used to represent translations and rigid rotations of lines and points in a 2-dimensional or 3-dimensional coordinate system. A transformation matrix is essentially the solution to a set of linear simultaneous equations, which may be solved using techniques taught in high school and college algebra classes.

For example, the specification of a first candidate component may include one or more axes and reference point locations described relative to a first local X-Y coordinate system. The specification of a second component may include coordinates of a point and/or axis at which it mates to the first component. The point and/or axis of the second component may be relative to a second X-Y coordinate system. The software 22 may then determine the rotation and translation necessary to transform all coordinates of the second component to coincide with the corresponding point and/or axis of the first component. In other words, all coordinates of the second component are rigidly transformed into new coordinates, which are relative to the first X-Y coordinate system. The transformation, in effect, virtually assembles the second component onto the first component. Then both components coordinates are relative to the same coordinate system.

Thereafter, a similar technique may be applied to a third component and so on until all coordinates of all candidate components are relative to one common coordinate system. The result is a virtual bicycle built of candidate bicycle components virtually moved into the correct positions by rotations and translations of the geometrical specifications of the components.

The transformations above may alternatively be performed more generally in 3 dimensions, but the rotations and translations of components for a bicycle generally can be thought of as taking place within the plane of the bicycle. That is, all components, axes, and referent points are in effect projected onto the plane of the bicycle frame.

In a preferred embodiment, the local X-Y coordinate system of the frame is the coordinate system into which the coordinate pairs of all the other components are transformed. Therefore it is desirable that the local X-Y coordinate system of the frame is initially expressed as or is identical to the Reach-Stack coordinate system. In other, words, the X-Y coordinate system of each candidate bicycle frame preferably has the center of the bottom bracket as the origin. Further, the X axis runs forward in a direction which will be horizontal, and the Y axis will be vertical, when the frame is part of an assembled physical bicycle. Nevertheless, if the frame's local X-Y coordinate system differs from a Reach-Stack coordinate system, a final matrix transformation may be applied to all X-Y coordinate pairs to transform them into corresponding coordinate pairs relative to a Reach-Stack coordinate system.

In a preferred embodiment, the virtual assembly of a bicycle configuration may be a necessary intermediate step for computing a certain attribute value, such as a distance between specific reference points on two candidate components of a candidate configuration. The virtual assembly of a whole candidate bicycle can be based on a local X-Y coordinate system of the frame. Preferably, but not necessarily, the local X-Y coordinate system of the frame may be defined to be identical to a Reach-Stack coordinate system for the whole, assembled bicycle configuration. This is convenient, because the bottom bracket may be chosen as the origin of the Reach-Stack coordinate system, and because the bottom bracket nearly always is an integral part of the frame. Therefore, the virtual assembly most naturally begins with a candidate bicycle frame and virtually assembles components incrementally into the frame.

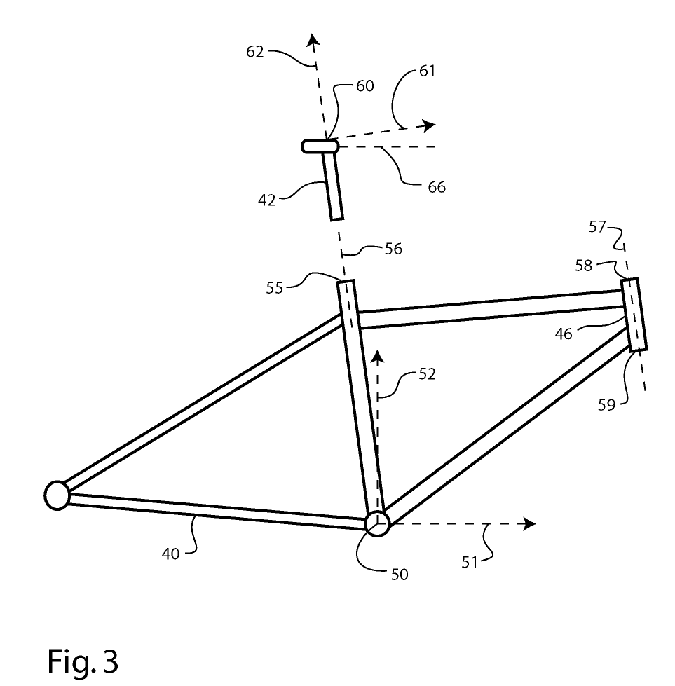

With reference to FIG. 3, the virtual assembly of a candidate bicycle will be illustrated using a candidate frame 40 and a candidate seat post 42 as examples. A similar explanation can apply to other candidate components to be added to the assembly being built.

A local X-Y coordinate system may be used to represent the locations of points and the directions of axes on the frame. Although a 3-dimensional coordinate system may be used instead, the 2-dimensional plane of symmetry of the frame suffices in general for the purposes herein. Thus, the axis of the bottom bracket may be assumed to be represented by the coordinate pair (0, 0), which is the coordinate system's origin 50. The local X axis 51 is here assumed to point forward and therefore may be identical to a Reach axis. The local Y axis 52 is here assumed to point vertically up and therefore may be identical to a Stack axis.

The top 55 of the seat tube (or its equivalent), the top 58 of the head tube 46, and the bottom 58 of the head tube 46 are points specified as coordinate pairs-preferably in the Reach-Stack coordinate system right from the start. In any case, those points are in the coordinate system of the frame. The centerline 56 of the seat tube may be represented in analytic geometry in any of several ways. For the purposes here, represent the centerline as a unit direction vector and some given point on the centerline. The top 55 of the seat tube may serve as the given point on the centerline. Note that the bottom bracket center should not be used as the given point, because the seat tube centerline 56 does not pass through the bottom bracket on some bicycle frames.

Similarly, the centerline 57 of the head tube 46 may be represented in analytic geometry as a unit direction vector and a given point on the centerline. The given point may be the point defining the top 58 of the head tube 46.

A candidate seat post 42 possesses a local X-Y coordinate system consisting of an origin 60, which may be somewhat arbitrary but may be chosen on the centerline 62 and on the top of the seat post 42. The top of the seat post may be defined as the plane in which the centerlines of the saddle rails are intended to be located. The local X axis 61 may run perpendicular to the centerline 62 of the seat post. The local Y axis 62 may be defined coincident with the centerline 62. The top of the seat post, or where the seat rails may run, that is if projected onto the X-Y plane, may be a significant reference point. Also, the centerline 66 of where a seat rail will be located may be defined as a point 60 and a unit direction vector relative to the local X-Y coordinates-both the point and the vector being projected onto the X-Y plane (unless a 3-d coordinate system is used).

To virtually assemble the seat post 42 onto the frame 40, the program 22 of the system 1 finds a transformation which in effect (1) will align the centerline 62 with the centerline 56, and (2) will place the top of the seat post 60 at the desired distance D from the bottom bracket's center 50. This may require knowledge of the height H of the top of a candidate saddle above the center of the rails of the saddle. In other words, D+H is the virtual distance of the top of the candidate saddle above the bottom bracket. This may be a common biomechanical constraint input into the system 1. The transformation may be calculated by first applying a rotation of A degrees to all local X-Y coordinates of the seat post 42, where A is the angle of the centerline 56 from the Y axis of the frame's coordinate system. The applying of the rotation simply means multiplying each coordinate pair of each point and direction vector with a 2-by-2 matrix such as this:
   |cos A −sin A|
   |sin A cos A|
   After the rotation, the coordinate pair of each point of the seat tube is then translated by adding the following offset vector to the coordinate pair:

S=(SX, SY)

such that S effectively places the top 60 of the seat post at the point on the seat tube centerline 56 which is the desired distance from the bottom bracket center 50. Note that in the transformation of the seat tube into its virtual position, the above vector S is not added to any unit direction vector of the specification of the seat post, such as the vector describing the centerline 62.

As part of choosing a candidate seat post for an already chosen candidate frame 40, the outside diameter of the seat post 42 must match the inside diameter of the seat tube of the frame 40. This is effectively an implicit constraint which may be built into the program 22. This implicit constraint may immediately eliminate many candidate seat posts from consideration as components in a candidate configuration. This may significantly reduce the number of viable frame-seat-post candidate configurations. The same matching of inside and outside diameters may hold also when pairing a fork to the frame 40, pairing a stem to a fork, pairing a handlebar to a stem, and so on.

Similarly, a candidate saddle can be virtually assembled onto the “augmented frame” which is now the seat post 42 virtually assembled onto the frame 40. That is, once any non-frame candidate component is virtually assembled onto the frame 40, the non-frame candidate component effectively is treated thereafter as part of the frame 40. Similarly, a candidate fork may be virtually inserted into the head tube 46, aligning centerlines of both the fork and the head tube 46, and placing the appropriate reference point of the fork at the bottom 59 of the head tube 46. Once the fork effectively becomes part of the frame 40, a candidate stem and thereafter a candidate handlebar and/or aerobar may be virtually assembled onto the growing combination of candidate components.

The kinds of physical bicycle components 7 represented virtually in the database 11 and which specifications are present in the database 11 may dictate what kinds of constraints the program 22 can accept as input. Further, the kinds of constraints the program 22 can accept as input may dictate what attribute values the program 22 may need to compute. Because of the importance of the posture of a cyclist, such as to maximize efficiency, Reach-Stack coordinates of key component reference points will computed in a preferred embodiment. From the Reach-Stack coordinates, the program 22 of a preferred embodiment may then compute a distance value between any given pair of reference points. Similarly, from the Reach-Stack coordinates, the program 22 of a preferred embodiment may then compute an angle among any triplet of reference points.

With reference to FIG. 2 again, an embodiment may be described as a method to generate a conforming subset 4 of candidate descriptions of bicycle configurations 2: step 100. A preferred embodiment may execute the steps of the method in the order to be explained below or may execute the steps in parallel or in any sequential order which generates a conforming subset 4.

The method includes accessing a database 11 of candidate bicycle components: step 102. Further, the method includes inputting at least one biomechanical constraint 6: step 104b. The constraint 6 may be input in any of the ways previously described and may be of any of the types previously described.

Instead of—or in addition to-directly inputting the biomechanical constraint or constraints, the method may input one or more of the following measurements: a measurement 32 measured on an existing bicycle or bicycle simulator; and/or a measurement 31 measured on a cyclist. From the one or more measurements, the method may automatically derive a constraint 6: step 104a. The deriving of the constraint 6 may take place in any of the ways previously described.

Optionally, the method may input operator-entered non-biomechanical constraints 36. The non-biomechanical constraints may include any, some, or all of those listed previously.

The conforming subset 4 of candidate descriptions will additionally conform to the non-biomechanical constraints 36.

With further reference again to FIG. 2, the method also includes generating a set of candidate bicycle configurations 2, which in effect are assembled combinations of candidate bicycle components from database 11: step 108. The method may then process and evaluate some or all of the candidate descriptions of bicycle configurations in the generated set: step 110. To perform the evaluation of each such candidate description, program 22 computes at least one attribute value for each candidate description: step 112. The computation of the at least one attribute value was previously discussed in some detail, and examples were provided above.

The process further includes determining whether the attribute value—and therefore the candidate description—conform to the constraint 6: step 114. If the candidate description does not conform to the constraint 6, then the candidate description is ignored: step 116. If the candidate description does conform to the constraint 6, the process includes the candidate description as an element of the conforming subset 4 of descriptions of the generated bicycle configurations: step 118.

While the present invention has been disclosed with reference to certain preferred embodiments, numerous variations, alterations, and changes to the described embodiments are possible without departing from the spirit and scope of the present invention, as defined in the appended claims. Accordingly, it is intended that the present invention not be limited to the described embodiments, but that it have the full scope defined by the language of the following claims, and equivalents thereof.

I claim

1. A system for generating a conforming subset of a set of candidate descriptions,
wherein each candidate description in the set of candidate descriptions corresponds to a bicycle configuration,
wherein each bicycle configuration includes two or more components from a set of candidate components, and
wherein each candidate description in the conforming subset conforms to a biomechanical constraint; comprising:
a database of the candidate components, which database associates a biomechanical specification with each candidate component; and
a programmable computer programmed
to access the biomechanical specifications of the candidate components in the database,
to input the biomechanical constraint,
to generate a set of candidate descriptions, each candidate description describing two or more of the candidate components in the database,
to compute an attribute value for each candidate description in the set of the candidate descriptions using the biomechanical specifications associated with the candidate components included in the candidate description, and
to determine whether the computed attribute value conforms to the biomechanical constraint, and
if the attribute value does conform to the biomechanical constraint, to include the candidate description in the conforming subset.

2. The system of claim 1, wherein the programmable computer is further programmed to input a non-biomechanical constraint to which the candidate description also conforms.

3. The system of claim 1, wherein the candidate component is a bicycle frame.

4. The system of claim 1, wherein the candidate component is a bicycle frame with an integral seat post.

5. The system of claim 1, wherein the candidate component is a seat post.

6. The system of claim 1, wherein the candidate component is a saddle.

7. The system of claim 1, wherein the candidate component is a front wheel fork.

8. The system of claim 1, wherein the candidate component is a handlebar.

9. The system of claim 1, wherein the candidate component is an aerobar.

10. The system of claim 1, wherein the candidate component is a crank set.

11. The system of claim 1, wherein the candidate component is a stem.

12. The system of claim 1, wherein the candidate component is an integrated combination of a stem and handlebar.

13. The system of claim 1, wherein the biomechanical constraint is derived from a dimensional measurement.

14. The system of claim 13, wherein the dimensional measurement is measured on a specific bicycle.

15. The system of claim 13, wherein the dimensional measurement is measured on a specific cyclist.

16. The system of claim 1, wherein the biomechanical constraint includes a distance.

17. The system of claim 16, wherein the distance measures a Euclidean distance between two points.

18. The system of claim 16, wherein the distance measures a horizontal distance.

19. The system of claim 16, wherein the distance measures a vertical distance.

20. The system of claim 16, wherein the distance is a distance between a bottom bracket and a handgrip.

21. The system of claim 16, wherein the distance is a distance between a bottom bracket and a point on top of a saddle.

22. The system of claim 16, wherein the is a distance between a point on the top of a saddle and a handgrip.

23. The system of claim 16, wherein the distance measures a rake distance of a front wheel fork.

24. The system of claim 16, wherein the distance measures a trail distance.

25. The system of claim 1, wherein the biomechanical constraint includes an angle.

26. The system of claim 25, wherein the measures a saddle angle.

27. The system of claim 25, wherein the angle measures a head tube angle.

28. The system of claim 1, wherein the conforming subset additionally satisfies a non-biomechanical constraint.

29. The system of claim 28, wherein the non-biomechanical constraint is a weight limit.

30. The system of claim 28, wherein the weight limit is a minimum weight.

31. The system of claim 28, wherein the weight limit is a maximum weight.

32. The system of claim 28, wherein the non-biomechanical constraint is a price range.

33. The system of claim 28, wherein the non-biomechanical constraint is a material.

34. The system of claim 28, wherein the non-biomechanical constraint is a frame style.

35. The system of claim 28, wherein the non-biomechanical constraint is a component brand.

36. The system of claim 28, wherein the non-biomechanical constraint is a handling characteristic.

37. The system of claim 1, wherein the computed attribute is a range of distances between two reference locations, each of the reference locations belonging to one of the candidate components.

38. The system of claim 1, wherein the computed attribute is a range of coordinates in a coordinate system.

39. The system of claim 1, wherein the computed attribute is a range of angles.

40. A method of generating a conforming subset of a set of candidate descriptions,
wherein each candidate description in the set of candidate descriptions describes a bicycle configuration,
wherein each candidate description includes two or more components chosen from a set of candidate components, and
wherein each description in the conforming subset of the set of candidate descriptions conforms to a biomechanical constraint; comprising:
accessing a database of specifications of the candidate components;
inputting the biomechanical constraint;
optionally inputting a non-biomechanical constraint;
generating a candidate description of a candidate bicycle configuration, wherein each candidate description references two or more of the candidate components computing an attribute value as a function of the candidate description of the candidate bicycle configuration;
determining whether the attribute value conforms to the biomechanical constraint; and
if the attribute value does conform to the biomechanical constraint, including the candidate configuration in the conforming subset of the set of candidate descriptions.

41. The method of claim 40, wherein the generating further comprises inputting a non-biomechanical constraint to which the candidate description also conforms.

42. The method of claim 40, wherein the determining whether the attribute value conforms to the biomechanical constraint further comprises deriving the biomechanical constraint from a dimensional measurement.

43. The method of claim 42, wherein the dimensional measurement is measured on a specific bicycle.

44. The method of claim 42, wherein the dimensional measurement is measured on a specific cyclist.

45. The method of claim 40, wherein the biomechanical constraint includes a distance.

46. The method of claim 45, wherein the distance measures a Euclidean distance between two points.

47. The method of claim 45, wherein the distance measures a horizontal distance.

48. The method of claim 45, wherein the distance measures a vertical distance.

49. The method of claim 45, wherein the distance is a distance between a bottom bracket and a handgrip.

50. The method of claim 45, wherein the distance is a distance between a bottom bracket and a point on top of a saddle.

51. The method of claim 45, wherein the distance is a distance between a point on the top of a saddle and a handgrip.

52. The method of claim 45, wherein the distance measures a rake distance of a front wheel fork.

53. The method of claim 45, wherein the distance measures a trail distance.

54. The method of claim 40, wherein the biomechanical constraint includes an angle.

55. The method of claim 54, wherein the angle measures a saddle angle.

56. The method of claim 54, wherein the angle measures a head tube angle.

57. The method of claim 40, wherein the conforming subset additionally satisfies a non-biomechanical constraint.

58. The method of claim 57, wherein the non-biomechanical constraint is a weight limit.

59. The method of claim 57, wherein the weight limit is a minimum weight.

60. The method of claim 57, wherein the weight limit is a maximum weight.

61. The method of claim 57, wherein the non-biomechanical constraint is a price range.

62. The method of claim 57, wherein the non-biomechanical constraint is a material.

63. The method of claim 57, wherein the non-biomechanical constraint is a frame style.

64. The method of claim 57, wherein the non-biomechanical constraint is a component brand.

65. The method of claim 57, wherein the non-biomechanical constraint is a handling characteristic.
